(19) United States
(12) Patent Application Publication
(10) Pub. No.: US 2016/0314408 A1
(43) Pub. Date: Oct. 27, 2016

(54) LEVERAGING LEARNED PROGRAMS FOR DATA MANIPULATION

(71) Applicant: Microsoft Technology Licensing, LLC, Redmond, WA (US)

(72) Inventors: Sumit Gulwani, Bellevue, WA (US); Sree Hari Nagaralu, Hyderabad (IN); Ranganath Kondapally, Hyderabad (IN); Vijayendra G. Vasu, Hyderabad (IN); Karthikeyan Raman, Hyderabad (IN)

(73) Assignee: MICROSOFT TECHNOLOGY LICENSING, LLC, Redmond, WA (US)

(21) Appl. No.: 14/691,815

(22) Filed: Apr. 21, 2015

(51) Int. Cl. G06N 99/00; G06N 5/04

(52) U.S. Cl. CPC G06N 99/005; G06N 5/048

(57) ABSTRACT

Examples of the present disclosure describe leveraging of learned programs for data manipulation. A template associated with information including non-marked up content is detected by applying machine learning processing that compares the information with a plurality of stored templates. The learned program is detected from a learned program pool comprising a plurality of learned programs based on the template detected. Extracted data from the information is manipulated based on application of the learned program. Other examples are also described.

### BACKGROUND

Most users of systems and applications are unable to develop program code for executing a data manipulation processing operation. As a result, users fall back on programmers/developers to write code to accomplish such processing. Programmers typically develop programming solutions that are domain-specific and designed to work with marked-up content. However, most information accessible by users is unstructured. It is with respect to this general technical environment that the present application is directed.

### SUMMARY

Examples of the present disclosure describe leveraging of learned programs for data manipulation. A template associated with information including non-marked up content is detected by applying machine learning processing that compares the information with a plurality of stored templates. A learned program pool is determined based on the template detected. The learned program is detected from a learned program pool comprising a plurality of learned programs. Extracted data from the information is manipulated based on application of the learned program. Other examples are also described.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates an overview an example system for generation of a learned program as described herein.

FIG. 2 illustrates an overview of an example system for leveraging created learned programs as described herein.

FIG. 3A illustrates an overview of an example process flow for template detection from information as described herein.

FIG. 3B illustrates an overview of an example process flow of determining a learned program based on template detection as described herein.

FIG. 4 illustrates an example method of leveraging learned programs as described herein.

FIG. 5 is a block diagram illustrating an example of a computing device with which aspects of the present disclosure may be practiced.

FIGS. 6A and 6B are simplified block diagrams of a mobile computing device with which aspects of the present disclosure may be practiced.

FIG. 7 is a simplified block diagram of a distributed computing system in which aspects of the present disclosure may be practiced.

### DETAILED DESCRIPTION

A system and/or service of the present disclosure provides learned program creation and leveraging of learned programs usable to perform data manipulation operations such as information tagging and extraction, among other examples. Systems/services of the present disclosure create a learned program from user input operations through example based learning. A learned program is a sequence of operation or instructions, created to perform a specified task based on example operations performed by a user. In examples, a user shows a system/service how to perform a specific operation once and the system/service of the present disclosure is able to automatically generate a learned program for performing the task or an operation similar to the task. A task is an executable operation. Examples of tasks include but are not limited to: information tagging, information extraction, information review, information retrieval, and information processing, among other examples. Created learned programs may be leveraged for users of the system/service for data manipulation processing.

As one of many examples, a user may wish to extract information from a passport document or a scanned copy of a passport. In that instance, the user may mark the location of a name of the passport holder and a passport number, tagging such information using a user interface of the present disclosure. A learned program may be automatically created by the system/service for tagging and extracting passport information. Whenever a new document, image etc. is presented, a system/service of the present disclosure identifies that a user is working with a passport document and may automatically detect a learned program to apply, executing operations to extract passport information. For example, when a passport file/scanned copy of a passport is opened or passport information is viewed on a webpage, the system/service of the present disclosure can automatically detect and apply a learned program that performs data manipulation such as extracting the passport information for the user. If a learned program has not previously been created for a certain task such as passport number extraction, a user interface of the system/service associated with the present disclosure may automatically create a learned program from user-provided examples. Once a learned program is created, it may be stored and leveraged by the system/service of the present disclosure to be applied to perform similar tasks or operations by the user that created the program as well as other users of the system/service. In examples, the system/service creates and maintains a large repository of such learned programs that it may intelligently apply based on a document/file/image etc. that is being viewed, worked with, etc. Applications/services and/or application domains that may utilize data manipulation examples described in the preset disclosure include but are not limited to: data mining, information discovery domains (e.g., legal eDiscovery services), data analytics (e.g., any data analysis such as text analytics for unstructured Big Data), log evaluation (e.g., web logs, query logs, telemetry data, system logs, error logs, etc.), data loss prevention, and data leak prevention, among other examples. One skilled in the art will recognize that examples described in the present disclosure can be applicable to any application domains or services.

Accordingly, the present disclosure provides a plurality of technical effects including but not limited to: automatic program generation from example based operations, minimizing the need for developers/programmers to write custom programs to execute tasks, reducing the time required to complete the task (e.g., manually programming code for task processing), increased processing efficiency in task completion/learned program creation, detection of similarities between created learned programs and information/data being viewed/worked with, scalability in creating and leveraging learned programs, improved efficiency and usability for applications including the ability to work with any type of content (e.g., structured, semi-structured, unstructured, marked-up, non-marked up, etc.), and control over user interaction for learned program creation and leveraging, among other examples.

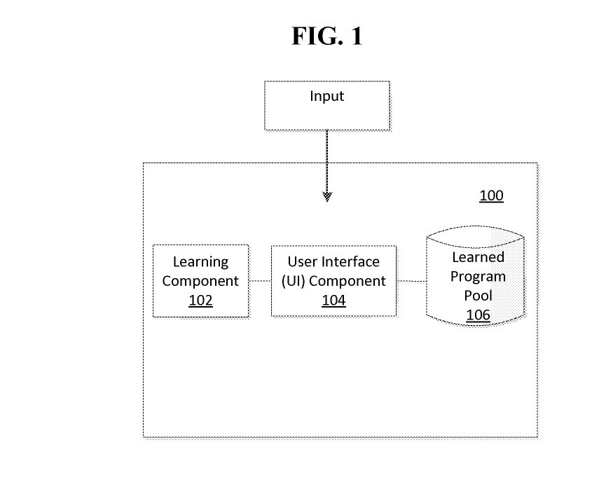

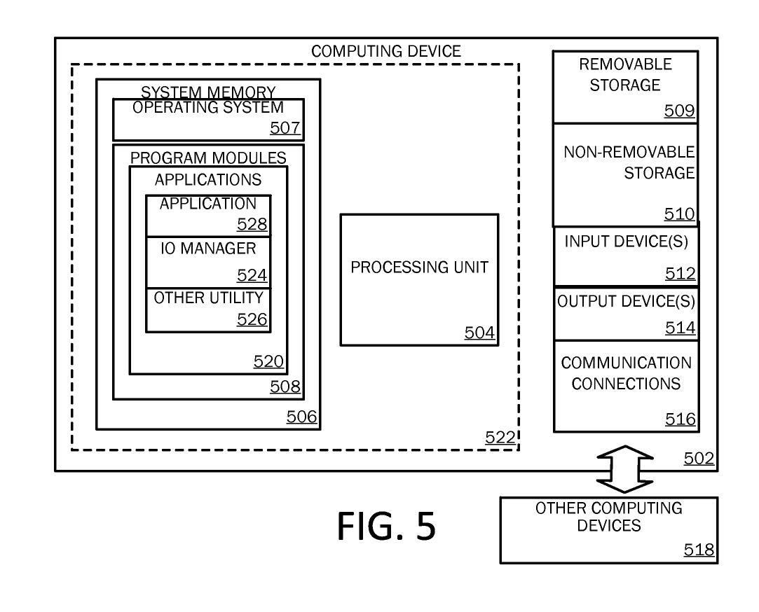

FIG. 1 illustrates an overview of an example system for generation of a learned program as described herein. Exemplary system 100 presented is a combination of interdependent components that interact to form an integrated whole for learned program generation based on user example operations. Components of the systems may be hardware components or software implemented on and/or executed by hardware components of the systems. In examples, system 100 may include any of hardware components (e.g., ASIC, processor, etc., used to execute/run operating system (OS)), and software components (e.g., applications, application programming interfaces, modules, virtual machines, runtime libraries, etc.) running on hardware. In one example, an exemplary system 100 may provide an environment for software components to run, obey constraints set for operating, and makes use of resources or facilities of the system 100, where components may be software (e.g., application, program, module, etc.) running on one or more processing devices. For instance, software (e.g., applications, operational instructions, modules, etc.) may be run on a processing device such as a computer, mobile device (e.g., smartphone/phone, tablet) and/or any other electronic devices. As an example of a processing device operating environment, refer to operating environments of FIGS. 5-7. In other examples, the components of systems disclosed herein may be spread across multiple devices. For instance, input may be entered on a client device (e.g., processing device) and information may be processed or accessed from other devices in a network such as one or more server devices.

As one example, the system 100 comprises a learning component 102, a user interface component 104, and a learned program pool 106, each having one or more additional components. One of skill in the art will appreciate that the scale of systems such as system 100 may vary and may include more or fewer components than those described in FIG. 1. In some examples, interfacing between components of the system 100 may occur remotely, for example where components of system 100 may be spread across one or more devices of a distributed network.

The data learning component 102 is configured to control synthesis and execution of a learned program for manipulating data from an input (e.g., information) based on example(s). The learning component enables structured data (e.g., an instance of an output data schema) to be extracted from various input types, for example, unmarked content. Moreover, the learning component 102 supports a uniform user interaction processing across different inputs/input types. Exemplary inputs include but are not limited to: any type of marked-up content, un-marked content, semi-structured content, mail data (e.g., e-mail message), text/mobile messages (e.g., SMS) or notifications, conversations, log files, social feed data (e.g., RSS feeds), file data (e.g., text files, log files, video files, word processor documents), spreadsheets, webpages, fixed-layout documents (e.g., Portable Document Format (PDF) documents), audio data, image data/files (e.g., photographs, scanned images, medical prescriptions, offers/advertisements, flyers, etc.), legal documents, printed documents, and catalogues, among other examples. Such input can combine model and view, which can enable data to be organized (e.g., possibly hierarchically); however, conventionally it is difficult to extract data from these types of input documents for further manipulation or querying.

As an example, the learning component 102 leads to improved user efficiency for performing data extraction tasks on the data of the input as compared to conventional techniques. For instance, a user need not learn how to create a program to extract data from input. Moreover, a user need not take the time to generate the program to extract data from the input. Further, a user need not understand the underlying formatting details or presentation logic of the input. Furthermore, user interaction performance can be improved in comparison to conventional techniques since the user can provide examples via a uniform user interface (e.g., user interface component 104), and program(s) for extracting data from the input can be synthesized and executed based on such examples.

The learning component 102 interfaces with the user interface component 104 to interact with users and guide users through creation and/or leveraging of learned programs. The learning component 102 can use examples provided by a user to extract data from the input. In one example, the learning component 102 (where a user is guided by the user interface component 104), processes examples indicative of data manipulation from input information. For instance, the examples can specify various fields to be tagged and/or extracted from input information. Data manipulation can relate to any operations performed on an input including but not limited to: reviewing, selecting, inserting, deleting, modifying, updating, tagging, extracting, viewing, copying, cutting, pasting, notifying and organizing, among other examples. However, one skilled in the art will recognize that the present disclosure is not limited to such data manipulation examples. Learned programs can be created and leveraged for any type of operational processing.

Further, the learning component 102 can be configured to relate the fields specified by the examples in a hierarchical organization using structure and sequence constructs. For instance, the user interface component 104 can be configured to receive user input that the learning component 102 defines as an output data schema. An output data schema includes a hierarchical combination of structure and sequence constructs, for example a collection of manipulated data of the input information. As identified above, learned programs can be automatically generated from user example operations. That is, the learning component 102 may monitor user processing operations entered via the user interface component 104, and apply program synthesis processing to automatically generate a learned program from the example operations. Examples received by the learning component 102 can include one or more positive examples and/or one or more negative examples. For instance, at least one example for each construct of the output data schema can be received. The examples received can include highlighted regions (e.g., two-dimensional regions) on the input document 102; such highlighted regions can indicate fields to be extracted or structure boundaries (e.g., record boundaries) around related fields. In one example, a user may show system 100 data to be extracted from one or more e-mail messages. Example operations are any operations performed to accomplish a data manipulation objective of the user. For instance, example operations include but are not limited to actions such as: information selection, shape selection, image selection, lasso, voice input, touch input (e.g., dragging, flicking, clicking,) and device input (e.g., keyboard, mouse, etc.), among other examples.

In an example, a learned program can be synthesized (e.g., created) in a domain specific language (DSL) that provides appropriate abstractions for the type of the input. Moreover, the learned program can be executed on the input or similar inputs detected to extract an instance of an output data schema. For example, a user may receive monthly banking alerts/notifications from a bank. The user may create a program that extracts the date and an amount in an account from an alert. In that example, the learning component 102 may create a learned program for data extraction from banking alerts, and when future banking alerts are received, the learning component may intelligently detect (via machine learning processing) the banking alert and extract data (e.g., date and amount) to present to the user. The learning component 102 may enable the user to set when the created program may run as well as update the created program. For example, if the user desires after receiving a monthly banking alert that they want to also extract debit information from the banking alert, the learning component 102 may enable the created program to be modifiable or may intelligently create a new version of the learned program to store in the learned program pool component 206 (hereinafter “learned program pool”).

The learning component 102 is configurable to execute program synthesis processing to create learned programs. In one example, program synthesis processing may include inductive synthesis processing for core operators in a predefined library. Examples of core operators include but are not limited to mapping, filtering, merging, pairing, deleting, editing, and organizing, among other examples. For example, the learned program may be created in the DSL for the type of the input by executing the inductive synthesis processing for the core operators. Further, the DSL can be constructed from the predefined library of the core operators. For instance, if the input is a text file, then the DSL can be built for text files. Accordingly, the learning component 102 differs from conventional domain specific synthesizers since specialized program synthesis processing algorithms need not be developed, thereby reducing time and effort associated with creating an inductive synthesizer for a given DSL. Thus, developers for system 100 can define a DSL with sufficient expressiveness to provide appropriate abstractions for data manipulation from an input and built out of the operators provided by the core library. Accordingly, specialized program synthesis processing algorithms need not be developed to create learned programs.

The user interface component 104 is an interface for the system 100 to interact with a user for creation and application/leveraging of learned programs. In one example, the user interface component 104 can be configured to generate a graphical representation for the user to interact with the system 100 including but not limited to operating systems, applications, modules, plug-ins/add-ons, and application command control, among other examples. For instance, in viewing input, fields or structure boundaries within the graphical representation of the input can be highlighted to provide the examples to the learning component 102. In one example, the user interface component 104 is independent of an underlying type of the input. A user interface supported by system 100 can be uniform across different input types. In examples, the user interface component 102 is able to interact with the user through multiple types of input. For instance, the user interface component 102 may recognize data manipulation input/operational processing (via communication with the learning component 102) as well as commands/queries (e.g., voice or natural language commands) for creation and leveraging of learned programs.

It is contemplated that the examples received by the user interface component 104 can be received from a user of system 100 (e.g., the user provides the examples via input device(s)). In one example, examples or processing actions/operations received through the user interface component 104 can be transmitted from a client computing device via input device(s) and network connections associated with the client computing device where data may be communicated to system 100 operating on another processing device such as a server. The user interface component 104 is enabled to interface with a user by any form including but not limited to touch input, device input and voice input, among other examples. For example, the user interface component 104 provides an interface in which the user can specify/show interests for data manipulation processing. One such example of an interface could be showing a web page, where a user can draw a lasso around information that the user wants to extract. The user can shows one or more such examples of extracting data and the system 100 starts learning a program to extract data, for example, based on the examples. Another instance of interface interaction may be the user specifying in natural language, for example “I am interested in the text that looks like an address of the primary contact on this page.” Multiple different versions of the user interface may be generated for use and applicable with the user interface component 104.

The learned program pool 106 stores created learned programs for application and leveraging. In examples, the learning component 102 interfaces with the learned program pool 106 (and the user interface component 104) for creation and leveraging of learned programs. The learned program pool 106 comprises one or more storages/memories to maintain information on created learned programs, among other examples of information maintained by the learned program pool 106. When a learned program is created, system 100 transmits learned programs to be stored in the learned program pool 106. When a learned program is to be leveraged (e.g., for application by other users) component of systems/services may access the learned program pool 106 for accessing created learned programs or updating already created learned programs.

In addition to maintaining the created learned programs, the learned program pool 106 also maintains data associated with a learned program such as template information associated with a learned program. Template information includes any data associated with creation of an input or data that can be used to analyze layout and/or content of an input. Examples of template information include but are not limited to: data extraction templates, marked-up content (e.g., webpage templates), formatting information, abstracts/summaries of non-marked up content, video data, audio data, file data (e.g., scanned documents, bills, prescriptions, records, deeds, etc.), and social feeds, among other examples. Such information is continuously collected and updated by the learned program pool 106, for detection of learned programs to apply to various inputs/input types.

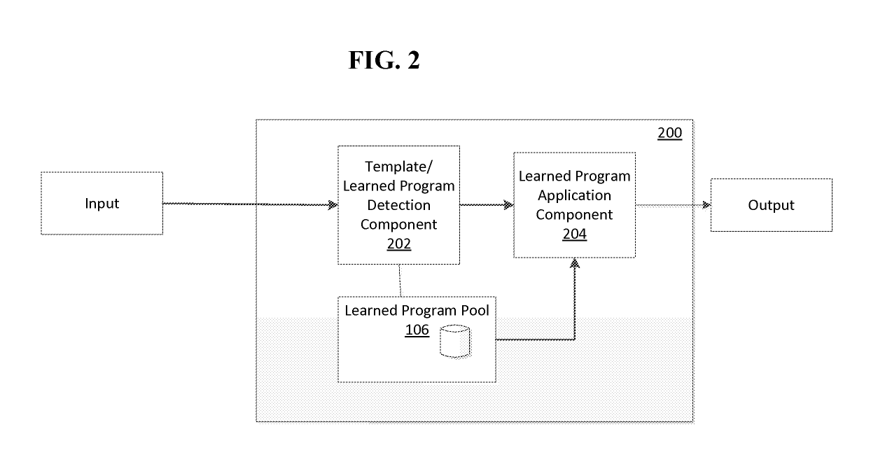

FIG. 2 illustrates an overview of an example system 200 for leveraging created learned programs as described herein. Created learned programs leveraged by system 200 comprise learned programs created by system 100 as described in FIG. 1. In alternative examples, a single system (comprising one or more components such as processor and/or memory) may perform processing described in systems 100 and 200, respectively. Further, system 200 may comprise a user interface component such as user interface component 104 described in the description of FIG. 1. A user interface component may be used to usable to interact with a user for monitoring interaction with system 200 (e.g., processing device) including identifying input for creation or leveraging of learned programs.

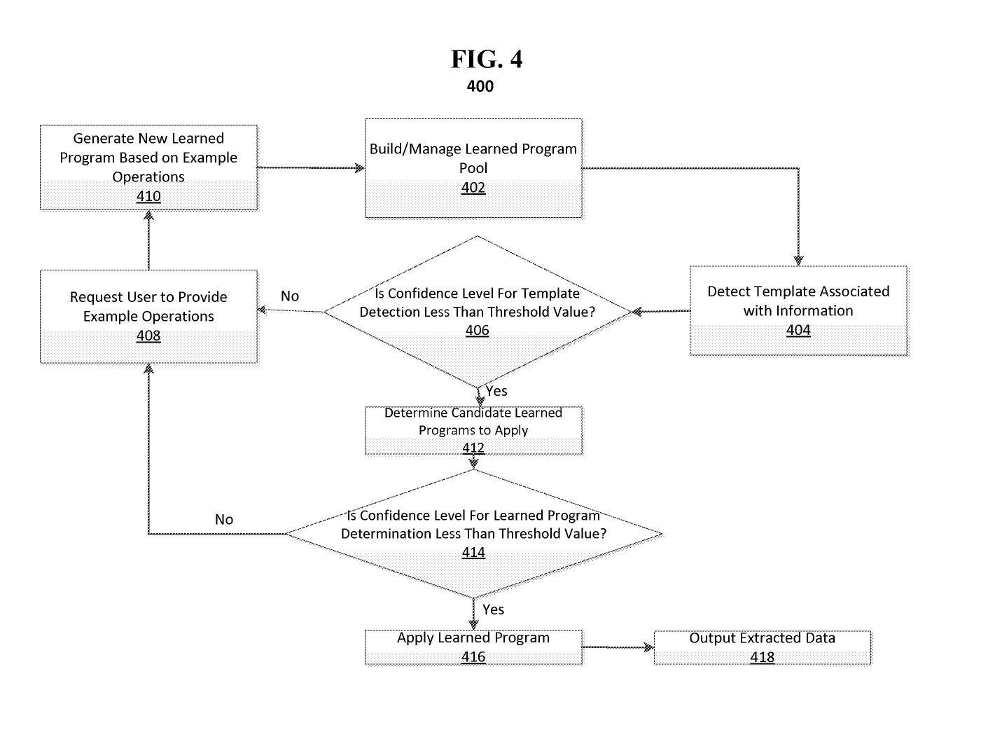

Exemplary system 200 presented is a combination of interdependent components that interact to form an integrated whole for leveraging of learned programs. Components of the systems may be hardware components or software implemented on and/or executed by hardware components of the systems. In examples, system 200 may include any of hardware components (e.g., used to execute/run operating system (OS)), and software components (e.g., applications, application programming interfaces, modules, virtual machines, runtime libraries, etc.) running on hardware. In one example, an exemplary system 200 may provide an environment for software components to run, obey constraints set for operating, and makes use of resources or facilities of the system 200, where components may be software (e.g., application, program, module, etc.) running on one or more processing devices. For instance, software (e.g., applications, operational instructions, modules, etc.) may be run on a processing device such as a computer, mobile device (e.g., smartphone/phone, tablet) and/or any other electronic devices. As an example of a processing device operating environment, refer to operating environments of FIGS. 4-7. In other examples, the components of systems disclosed herein may be spread across multiple devices. For instance, input may be entered on a client device (e.g., processing device) and information may be processed or accessed from other devices in a network such as one or more server devices.

As one example, the system 200 comprises a template/learned program detection component 202, a learned program application component 204, and the learned program pool 106, each having one or more additional components. One of skill in the art will appreciate that the scale of systems such as system 200 may vary and may include more or fewer components than those described in FIG. 2. In some examples, interfacing between components of the system 200 may occur remotely, for example where components of system 200 may be spread across one or more devices of a distributed network.

The template/learned program detection component 202 detects a learned program to leverage/apply based on evaluation of an input or input type. Input is described in the description of FIG. 1. In one example, the template/learned program detection component 202 of system 200 continuously monitors input (e.g., via a user interface component) that a user is working with or that is received (e.g., message/notification, etc.) That is, system 200 monitors a plurality of sources including but not limited to email accounts, messages, social media/social feeds, files/computer-readable storage devices, and digital libraries, among other examples, for application of learned programs.

Upon identifying an input, the template/learned program detection component 202 maps a template or structure of an input to a template using machine learning processing such as heuristic machine learning processing and/or template processing algorithms or operations. In one example, template/fingerprint template processing is applied to evaluate a template (e.g., fingerprint) of an input. A template is any data that can be evaluated to determine an input (or information associated with an input). In one example, machine learning processing is applied to learn data associated with an input (e.g., format of a document and/or content included in an input). Examples of machine learning processing applied to evaluate a template include but are not limited to processing for: data/concept mining, data extraction, feature hashing, natural language evaluation, w-shingling, n-gram/word-gram detection, statistical analysis, ranking (e.g., confidence value determinations), etc.

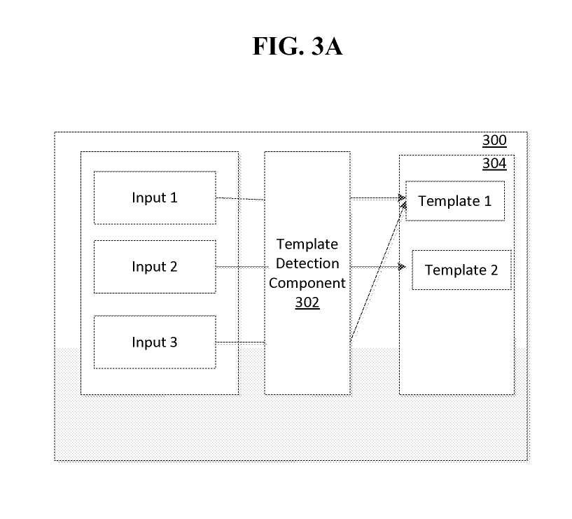

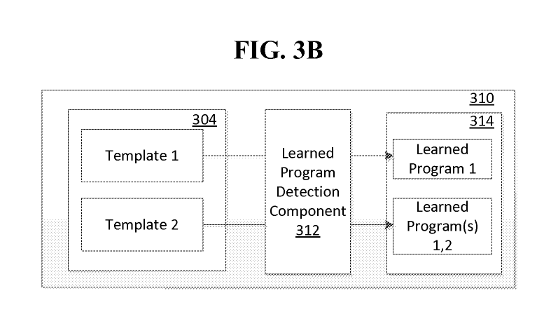

In examples, an input may be associated with one or more templates. As an example, FIG. 3A illustrates a process flow 300 for template detection from one or more inputs. In examples, the template/learned program detection component 202 may detect a template associated with an input and match the template of the input with one of a plurality of stored templates (e.g., template information). Template/learned program detection component 202 may use machine learning processing to determine a confidence level associated with template detection and rank stored templates based on likelihood that an input is associated with a stored template, as examples. If a learned program is not determined (e.g., confidence level is not achieved to apply a learned program), the template/learned program detection component 202 may request (or alternatively receive a request) creation of a learned program.

Moreover, the template/learned program detection component 202 associates the template of the input with one or more learned programs stored in the learned program pool 106, based on detection of a template for an input. The template/learned program detection component 202 maps a template to a learned program from the learned program pool 106 using machine learning processing such as heuristic machine learning processing and/or template processing algorithms or operations. Heuristic machine learning processing is any processing that can learn from data associated with a template to approximate a best possible between a template of the input and one or more templates of learned programs. Template processing algorithms/operations is any processing that can evaluate data characteristics of a template or data within a template to match a template of the input with one or more templates of learned programs. In another example, mapping of a template to a learned program is achieved by processing that runs one or more learned programs in the learned program pool 106 and evaluates, using a confidence level, extracted outputs of a learned program with stored templates in order to map a stored template with a learned program. In an example, learned programs are run without any pre-filtering. However, filtering can be applied in other examples.

In examples, a template may be associated with one or more learned programs. As an example, FIG. 3B illustrates a process flow 310 for determining a learned program(s) to apply. In examples, the template/learned program detection component 202 matches learned programs to templates using machine learning processing to determine a confidence level associated with learned program detection and ranking of applicable learned programs, as examples. If a learned program is not identified for applicable (e.g., confidence level is not achieved to apply a learned program), the template/learned program detection component 202 may request (or alternatively receive a request) creation of a learned program.

System 200 further comprises a learned program application component 204. The learned program application component 204 executes one or more learned programs for data manipulation. As an example, the learned program application component 204 may apply data manipulation processing, extracting data for output. However, one skilled in the art will recognize that application of a learned program is not limited to data extraction. An output is any result of application of a learned program. For instance, the learned program application component 204 may perform operations including aggregating and exporting extracted data into a collection of extracted values. In that example, an output may be a collection of extracted values (e.g., in a document, file, notification, etc.). In at least one example, an output may be channeled to be used by another application or service. As examples, the output could be transmitted to one or more databases, input into another application through an application pipeline connecting two or more applications, or can be presented as a data feed or rich site summary (RSS) feed, among other examples.

In examples, the learned program application component 204 may further determine how to present an output such as how to notify a user of content (e.g., instant display, download, message, notification, reminder, phone call, etc.). For example, system 200 may enable users of system 200 or a service associated with system 200, to specify how an output should be presented. Specification of presentation may occur in creation of a learned program or through the use of an application command control that may not be specific to a learned program.

FIG. 3A illustrates an overview of an example process flow 300 for template detection from information as described herein. Process 300 illustrated in FIG. 3A is exemplary processing by a system or service performing template detection from input such as the template/learned program detection component 202 described in FIG. 2. An input as shown in FIG. 3A is an input as previously described in the description of system 100 and system 200. In one example, input (e.g., one or more inputs) may be associated with a template (e.g., one or more templates) to enable accurate detection of a learned program that may be applied to an input. Template detection component 302 is a component (hardware or software) configured to detect a template associated with an input. As an example, template detection component 302 may perform operations similar to template/learned program detection component 202 as described in FIG. 2. For instance, template detection component 302 applies machine learning processing to identify a template associated with an input. Based on the machine learning processing, the template detection component 302 identifies as output (block 304), one or more templates that match an input. For instance, one or more inputs may be associated with one or more templates. In one example, input 1 and input 3 are associated with template 1 and input 2 is associated with template 2.

FIG. 3B illustrates an overview of an example process flow 310 of determining a learned program based on template detection as described herein. Process 310 illustrated in FIG. 3B is exemplary processing by a system or service performing learned program leveraging such as the template/learned program detection component 202 described in FIG. 2. Learned program detection component 312 is a component (hardware or software) configured to determine a learned program to apply based on detection of a template associated with an input. In one example, templates (e.g., one or more templates) may be associated with learned programs (e.g., one or more learned programs) to enable accurate detection of a learned program that may be applied to an input. As an example, learned program detection component 312 may perform operations similar to template/learned program detection component 202 as described in FIG. 2. For instance, learned program detection component 312 applies machine learning processing to identify whether one or more learned programs can be applied to an input based on detection of a template associated with an input. Based on the machine learning processing, the learned program detection component 312 identifies as output (block 314), one or more learned programs that can be used to manipulate data of an input. In examples where more than one learned program is associated with a template, the learned program detection component 312 may apply machine learning processing to rank learned programs for application to a particular input. In one example, extracted outputs of a learned program can be evaluated and a confidence level can be determined to identify whether the learned program is applicable to a particular input. In other examples, a system/service may present a user with one or more learned programs to choose from before applying a learned program.

FIG. 4 illustrates an example method 400 of leveraging learned programs as described herein. As an example, method 400 may be executed by an exemplary system such as system 100 of FIG. 1 and system 200 of FIG. 2. In examples, method 400 may be executed on a device comprising at least one processor configured to store and execute operations, programs or instructions. However, method 400 is not limited to such examples. In other examples, method 400 may be performed an application or service for learned program generation and management. In at least one example, method 400 may be executed (e.g., computer-implemented operations) by one or more components of a distributed network, for instance, web service/distributed network service (e.g. cloud service) to leverage learned programs for data manipulation processing.

Method 400 may begin at operation 402 where a learned program pool is built or developed. A learned program pool may be learned program pool 106 as detailed in the description of FIG. 1. In one example, a user of a systems/service may create a learned program through a user interface that enables a user to describe data manipulation processing steps and applicable data fields through example operations. As an example, a user, by providing operation examples, may extract data from an input. When a learned program is created, the learned program is aggregated into the learned program pool. The system/service learns a program and associates a learned program with a template (e.g., stored templates of the learned program pool). In examples, an input format and/or input type is identified at the time a learned program is associated with a learned program pool.

In an exemplary user interface, similar input (e.g., documents, mail, files, etc.) and/or learned programs to apply may be displayed for the user. The user interface also provides functionality for a user to mark any identified input, template or learned program, as correct or incorrect. In examples, telemetry data regarding correctness of input/template/learned program identification may be reported and used to adapt the system/service. For instance, based on user input and/or telemetry data, the system/service can adaptively re-learn machine learning processing to apply for leveraging of learned programs.

In operation 404, a template (e.g. fingerprint) associated with information (e.g., input) is detected. When a new input is identified by a system/service, machine learning processing is applied to automatically detect one or more templates associated with a particular input. In examples, the information being analyzed may include non-marked up content. The system/service examples described in the present disclosure provide an improvement over wrapper induction techniques, which typically only work with marked-up content. Operation 404 applies machine learning processing that compares the information with a plurality of stored templates to detect a template that matches the information. As described previously, a template may be mapped to a template of a learned program using machine learning processing such as heuristic machine learning processing and/or template processing algorithms or operations. Heuristic machine learning processing is any processing that can learn from data associated with a template to approximate a best possible between a template of the input and one or more templates of learned programs. Template processing algorithms/operations is any processing that can evaluate data characteristics of a template or data within a template to match a template of the input with one or more templates of learned programs. In another example, mapping of a template to a learned program is achieved by processing that runs one or more learned programs in a learned program pool and evaluates, using a confidence level, extracted outputs of a learned program with stored templates in order to map a stored template with a learned program. Operation 404 further comprises determining a confidence level for matching a stored template with a template associated with the information. A confidence level may be determined by executing at least one of heuristic machine learning processing and machine learning processing for fingerprint template recognition. At least one template is selected from a plurality of stored templates based on the confidence level determination.

In detection of a template, flow proceeds to decision operation 406, where it is determined whether the confidence level for template detection is less than a threshold value. The threshold value may be predetermined by developers of systems/services associated with the present disclosure. If the confidence level is less than the threshold, value flow may branch to operation 408 where a user is requested to provide example operations for analyzing the information. Based on the examples, provided by the user, a new learned program is generated (operation 410) from the example operations. Whenever, a new learned program is generated (operation 410), flow proceeds to operation 402 where the learned program pool is updated. When the confidence level for template detection is equal to or greater than the threshold value, flow branches to operation 412 where candidate learned programs are determined. Learned programs for application are determined (operation 412) based on application of machine learning processing comprising at least one of heuristic machine learning processing and machine learning processing for template recognition. Heuristic machine learning processing is any processing that can learn from data associated with a learned program to approximate a learned program that can be associated with a template for an input. Template processing algorithms/operations is any processing that can evaluate data characteristics of a template or data within a template of a learned program to match a template of the input with one or more learned programs. In another example, mapping of a template to a learned program is achieved by processing that runs one or more learned programs in a learned program pool and evaluates, using a confidence level, extracted outputs of a learned program to select a learned program that may be utilized for an input. In any example, the machine learning processing evaluates compatibility of learned programs based on a detected template that is selected from machine learning processing of input information. Operation 412 further comprises determining a confidence level for matching a stored template with a learned program stored in the learned program pool. A confidence level may be determined by machine learning processing as described above.

In detection of a learned program to apply, flow proceeds to decision operation 414, where it is determined whether the confidence level for learned program determination is less than a threshold value. The threshold value may be predetermined by developers of systems/services associated with the present disclosure. If the confidence level is less than the threshold, value flow may proceed to operation 408 where a user is requested to provide example operations for analyzing the information. Based on the examples, provided by the user, a new learned program is generated (operation 410) from the example operations. Whenever, a new learned program is generated (operation 410), flow proceeds to operation 402 where the learned program pool is updated.

When the confidence level for template detection is equal to or greater than the threshold value, flow proceeds to operation 416 where one or more learned programs are applied. As an example, application of a learned program may manipulate extracted data from input information. For instance, applying the learned program may further comprise aggregating and exporting the extracted data into a collection of extracted values (e.g., an output). In examples, machine learning processing may be applied to estimate a confidence level associated with extracted values before outputting extracted values.

Flow may then proceed to output (operation 418) the extracted data. In other examples, the system/service may continue to interact with a user based on the output (operation 418) of the extracted data. In one example, outputting of the extracted data comprises presenting a collection of extracted values as a data feed for use by other applications. For instance, an output may be channeled to be used by another application or service. As examples, the output could be transmitted to one or more databases, input into another application through an application pipeline connecting two or more applications, or can be presented as a data feed or rich site summary (RSS) feed, among other examples.

FIGS. 5-7 and the associated descriptions provide a discussion of a variety of operating environments in which examples of the invention may be practiced. However, the devices and systems illustrated and discussed with respect to FIGS. 5-7 are for purposes of example and illustration and are not limiting of a vast number of computing device configurations that may be utilized for practicing examples of the invention, described herein.

FIG. 5 is a block diagram illustrating physical components of a computing device 502, for example a component of a system with which examples of the present disclosure may be practiced. The computing device components described below may be suitable for the computing devices described above. In a basic configuration, the computing device 502 may include at least one processing unit 504 and a system memory 506. Depending on the configuration and type of computing device, the system memory 506 may comprise, but is not limited to, volatile storage (e.g., random access memory), non-volatile storage (e.g., read-only memory), flash memory, or any combination of such memories. The system memory 506 may include an operating system 507 and one or more program modules 508 suitable for running software applications 520 such as application 528, IO manager 524, and other utility 526. As examples, system memory 506 may store instructions for execution. Other examples of system memory 506 may be components such as a knowledge resource or learned program pool, as examples. The operating system 507, for example, may be suitable for controlling the operation of the computing device 502. Furthermore, examples of the invention may be practiced in conjunction with a graphics library, other operating systems, or any other application program and is not limited to any particular application or system. This basic configuration is illustrated in FIG. 5 by those components within a dashed line 522. The computing device 502 may have additional features or functionality. For example, the computing device 502 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, a number of program modules and data files may be stored in the system memory 506. While executing on the processing unit 504, the program modules 508 (e.g., Input/Output (I/O) manager 524, other utility 526 and application 528) may perform processes including, but not limited to, one or more of the stages of the operational method 400 illustrated in FIG. 4, for example. Other program modules that may be used in accordance with examples of the present invention may include electronic mail and contacts applications, word processing applications, spreadsheet applications, database applications, slide presentation applications, input recognition applications, drawing or computer-aided application programs, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the computing device 502 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

The computing device 502 may also have one or more input device(s) 512 such as a keyboard, a mouse, a pen, a sound input device, a device for voice input/recognition, a touch input device, etc. The output device(s) 514 such as a display, speakers, a printer, etc. may also be included. The aforementioned devices are examples and others may be used. The computing device 504 may include one or more communication connections 516 allowing communications with other computing devices 518. Examples of suitable communication connections 516 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 506, the removable storage device 509, and the non-removable storage device 510 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 502. Any such computer storage media may be part of the computing device 502. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

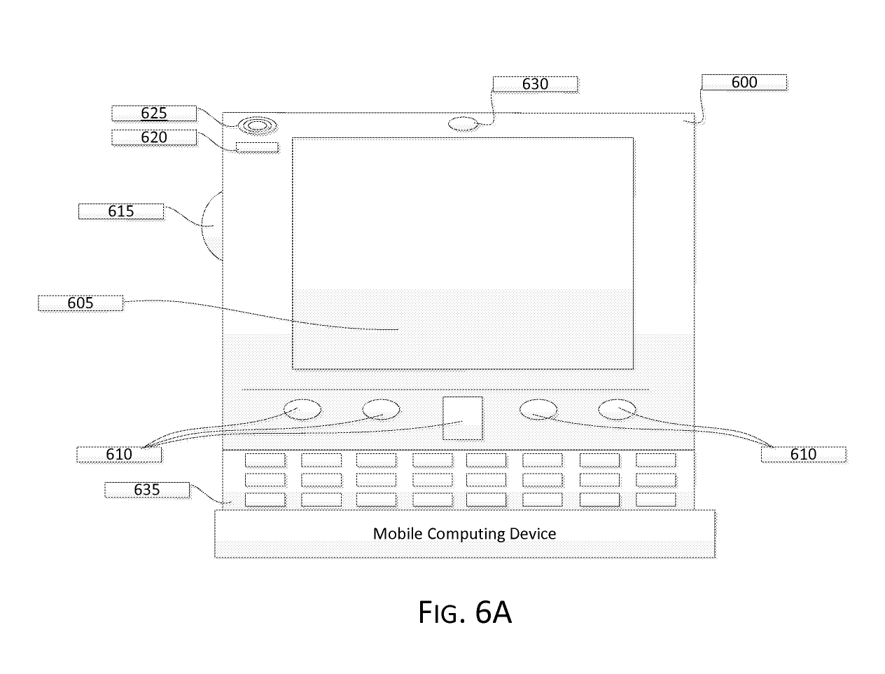

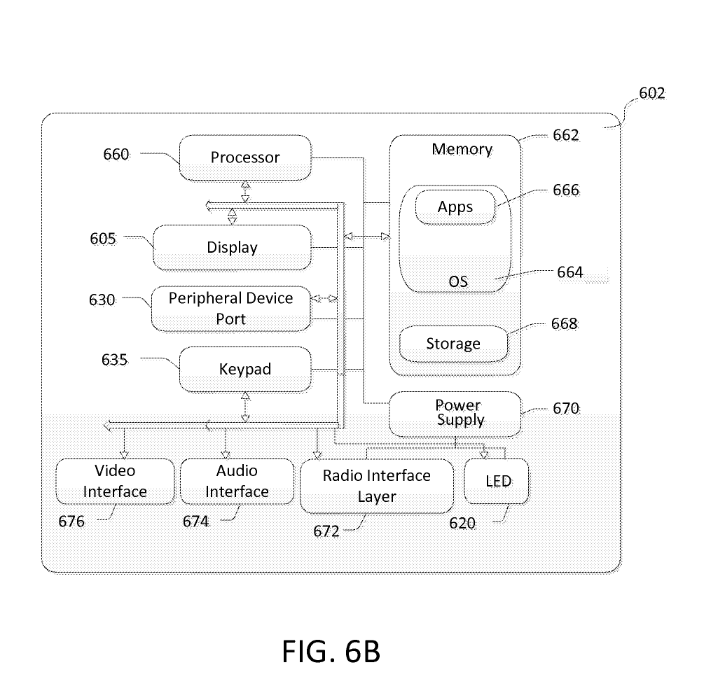

FIGS. 6A and 6B illustrate a mobile computing device 600, for example, a mobile telephone, a smart phone, a personal data assistant, a tablet personal computer, a laptop computer, and the like, with which examples of the invention may be practiced. For example, mobile computing device 600 may be implemented as system 100, components of systems 100 may be configured to execute processing methods as described in FIG. 4, among other examples. With reference to FIG. 6A, one example of a mobile computing device 600 for implementing the examples is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. The display 605 of the mobile computing device 600 may also function as an input device (e.g., a touch screen display). If included, an optional side input element 615 allows further user input. The side input element 615 may be a rotary switch, a button, or any other type of manual input element. In alternative examples, mobile computing device 600 may incorporate more or less input elements. For example, the display 605 may not be a touch screen in some examples. In yet another alternative example, the mobile computing device 600 is a portable phone system, such as a cellular phone. The mobile computing device 600 may also include an optional keypad 635. Optional keypad 635 may be a physical keypad or a “soft” keypad generated on the touch screen display. In various examples, the output elements include the display 605 for showing a graphical user interface (GUI), a visual indicator 620 (e.g., a light emitting diode), and/or an audio transducer 625 (e.g., a speaker). In some examples, the mobile computing device 600 incorporates a vibration transducer for providing the user with tactile feedback. In yet another example, the mobile computing device 600 incorporates input and/or output ports, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one example of a mobile computing device. That is, the mobile computing device 600 can incorporate a system (i.e., an architecture) 602 to implement some examples. In examples, the system 602 is implemented as a “smart phone” capable of running one or more applications (e.g., browser, e-mail, input processing, calendaring, contact managers, messaging clients, games, and media clients/players). In some examples, the system 602 is integrated as a computing device, such as an integrated personal digital assistant (PDA) and wireless phone.

One or more application programs 666 may be loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. The system 602 also includes a non-volatile storage area 668 within the memory 662. The non-volatile storage area 668 may be used to store persistent information that should not be lost if the system 602 is powered down. The application programs 666 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600, including application 528, IO manager 524, and other utility 526 described herein.

The system 602 has a power supply 670, which may be implemented as one or more batteries. The power supply 670 might further include an external power source, such as an AC adapter or a powered docking cradle that supplements or recharges the batteries.

The system 602 may include peripheral device port 678 that performs the function of facilitating connectivity between system 602 and one or more peripheral devices. Transmissions to and from the peripheral device port 672 are conducted under control of the operating system 664. In other words, communications received by the peripheral device port 678 may be disseminated to the application programs 666 via the operating system 664, and vice versa.

The system 602 may also include a radio 672 that performs the function of transmitting and receiving radio frequency communications. The radio 672 facilitates wireless connectivity between the system 602 and the “outside world,” via a communications carrier or service provider. Transmissions to and from the radio 672 are conducted under control of the operating system 664. In other words, communications received by the radio 672 may be disseminated to the application programs 666 via the operating system 664, and vice versa.

The visual indicator 620 may be used to provide visual notifications, and/or an audio interface 674 may be used for producing audible notifications via the audio transducer 625. In the illustrated example, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. In accordance with examples of the present invention, the microphone may also serve as an audio sensor to facilitate control of notifications, as will be described below. The system 602 may further include a video interface 676 that enables an operation of an on-board camera 630 to record still images, video stream, and the like.

A mobile computing device 600 implementing the system 602 may have additional features or functionality. For example, the mobile computing device 600 may also include additional data storage devices (removable and/or non-removable) such as, magnetic disks, optical disks, or tape. Such additional storage is illustrated in FIG. 6B by the non-volatile storage area 668.

Data/information generated or captured by the mobile computing device 600 and stored via the system 602 may be stored locally on the mobile computing device 600, as described above, or the data may be stored on any number of storage media that may be accessed by the device via the radio 672 or via a wired connection between the mobile computing device 600 and a separate computing device associated with the mobile computing device 600, for example, a server computer in a distributed computing network, such as the Internet. As should be appreciated such data/information may be accessed via the mobile computing device 600 via the radio 672 or via a distributed computing network. Similarly, such data/information may be readily transferred between computing devices for storage and use according to well-known data/information transfer and storage means, including electronic mail and collaborative data/information sharing systems.

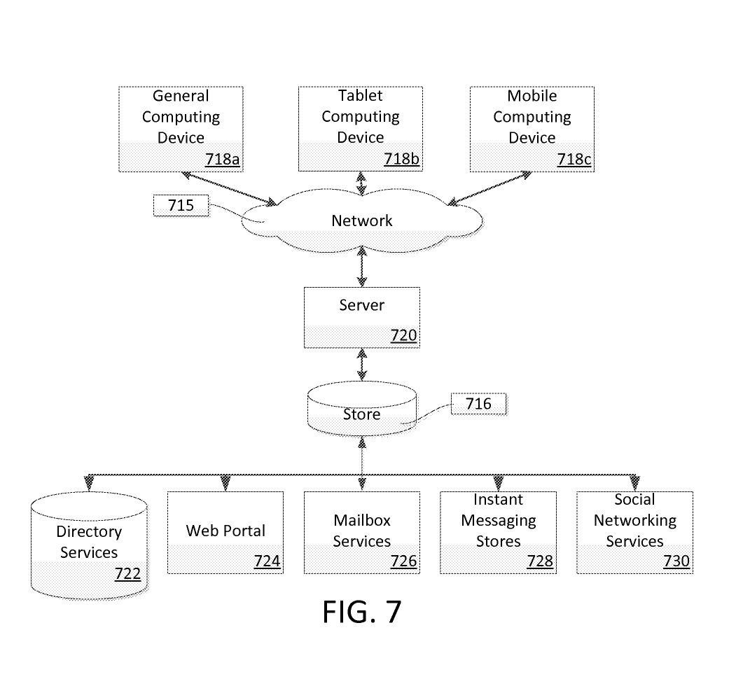

FIG. 7 illustrates one example of the architecture of a system for providing an application that reliably accesses target data on a storage system and handles communication failures to one or more client devices, as described above. Target data accessed, interacted with, or edited in association with application 528, IO manager 524, other utility 526, and storage may be stored in different communication channels or other storage types. For example, various documents may be stored using a directory service 722, a web portal 724, a mailbox service 726, an instant messaging store 728, or a social networking site 730, application 528, IO manager 524, other utility 526, and storage systems may use any of these types of systems or the like for enabling data utilization, as described herein. A server 720 may provide storage system for use by a client operating on general computing device 502 and mobile device(s) 600 through network 715. By way of example, network 715 may comprise the Internet or any other type of local or wide area network, and client nodes may be implemented as a computing device 502 embodied in a personal computer, a tablet computing device, and/or by a mobile computing device 600 (e.g., a smart phone). Any of these examples of the client computing device 502 or 600 may obtain content from the store 716.

Reference has been made throughout this specification to “one example” or “an example,” meaning that a particular described feature, structure, or characteristic is included in at least one example. Thus, usage of such phrases may refer to more than just one example. Furthermore, the described features, structures, or characteristics may be combined in any suitable manner in one or more examples.

One skilled in the relevant art may recognize, however, that the examples may be practiced without one or more of the specific details, or with other methods, resources, materials, etc. In other instances, well known structures, resources, or operations have not been shown or described in detail merely to observe obscuring aspects of the examples.

While sample examples and applications have been illustrated and described, it is to be understood that the examples are not limited to the precise configuration and resources described above. Various modifications, changes, and variations apparent to those skilled in the art may be made in the arrangement, operation, and details of the methods and systems disclosed herein without departing from the scope of the claimed examples.

What is claimed is:

1. A computer-implemented method comprising:
detecting a template associated with information including non-marked up content by applying machine learning processing that compares the information with a plurality of stored templates;
determining, from a learned program pool comprising a plurality of learned programs, a learned program to apply based on the template detected; and
applying the learned program to manipulate extracted data from the information.

2. The computer-implemented method according to claim 1, wherein the detecting of the template further comprises determining a confidence level for matching a stored template with a template associated with the information, and selecting a template from the plurality of stored templates based on the confidence level.

3. The computer-implemented method according to claim 2, wherein the confidence level is determined by executing at least one of heuristic machine learning processing and machine learning processing for fingerprint template recognition.

4. The computer-implemented method according to claim 2, wherein when the confidence level is less than a threshold value, requesting a user to provide example operations for analyzing the information, and creating a new learned program from the example operations using program synthesis processing.

5. The computer-implemented method according to claim 4, further comprising adding the new learned program to the learned program pool.

6. The computer-implemented method according to claim 1, wherein the learned program is determined based on application machine learning processing comprising at least one of heuristic machine learning processing and machine learning processing for template recognition.

7. The computer-implemented method according to claim 1, wherein the learned program is determined based on application of machine learning processing that runs the plurality of learned programs from the learned program pool and evaluates the extracted data from the plurality of learned programs using a confidence value associated with the extracted data.

8. The computer-implemented method according to claim 1, building the learned program pool comprising associating the plurality of learned programs with one or more of the stored templates.

9. The computer-implemented method according to claim 1, wherein applying the learned program further comprises aggregating and exporting the extracted data into a collection of extracted values, and outputting the collection of extracted values, wherein the outputting of the collection of extracted values comprises presenting the collection of extracted values as a data feed for use by other applications.

10. A system comprising:
a memory; and
at least one processor operatively connected with the memory, configured to execute operations comprising:
detecting a template associated with information including non-marked up content by applying machine learning processing that compares the information with a plurality of stored templates,
determining, from a learned program pool comprising a plurality of learned programs, a learned program to apply based on the template detected, and
applying the learned program to manipulate extracted data from the information.

11. The system according to claim 10, wherein the detecting of the template executed by the processor further comprises determining a confidence level for matching a stored template with a template associated with the information, and selecting a template from the plurality of stored templates based on the confidence level.

12. The system according to claim 11, wherein the confidence level is determined by executing at least one of heuristic machine learning processing and machine learning processing for fingerprint template recognition.

13. The system according to claim 11, wherein when the confidence level is less than a threshold value, requesting a user to provide example operations for analyzing the information, and creating a new learned program from the example operations using program synthesis processing.

14. The system to claim 13, where the operations executed by the processor further comprising adding the new learned program to the learned program pool.

15. The system according to claim 10, wherein the learned program is determined based on application machine learning processing comprising at least one of heuristic machine learning processing and machine learning processing for template recognition.

16. The system according to claim 10, wherein the learned program is determined based on application of machine learning processing that runs the plurality of learned programs from the learned program pool and evaluates the extracted data from the plurality of learned programs using a confidence value associated with the extracted data.

17. The system according to claim 10, wherein the operations executed by the processor further comprising building the learned program pool comprising associating the plurality of learned programs with one or more of the stored templates.

18. The system according to claim 10, wherein the applying of the learned program executed by the processor further comprises aggregating and exporting the extracted data into a collection of extracted values, and outputting the collection of extracted values, wherein the outputting of the collection of extracted values comprises presenting the collection of extracted values as a data feed for use by other applications.

19. A computer-readable storage device including executable instructions, that when executed on at least one processor, causing the processor to perform a process comprising:
detecting a template associated with information including non-marked up content by applying machine learning processing that compares the information with a plurality of stored templates,
determining, from a learned program pool comprising a plurality of learned programs, a learned program to apply based on the template detected, and
applying the learned program to manipulate extracted data from the information.

20. The computer-readable storage device according to claim 19, wherein the operations executed by the processor further comprising building the learned program pool comprising associating the plurality of learned programs with one or more of the stored templates, and
outputting the extracted data manipulated based on application of the learned program.
